(19) United States
(12) Patent Application Publication
(10) Pub. No.: US 2017/0174818 A1
(43) Pub. Date: Jun. 22, 2017

(54) POLYURETHANE FOAMS AND METHOD FOR PRODUCING SAME

(71) Applicant: Lubrizol Advanced Materials, Inc., Cleveland, OH (US)

(72) Inventors: Joseph J. VONORCIK Jr., Broadview Hts., OH (US); Julius FARKAS, North Ridgeville, OH (US); Ungyeong JUNG, North Royalton, OH (US); Kenneth H. KIM, Hudson, OH (US)

(21) Appl. No.: 15/128,620

(22) PCT Filed: Feb. 19, 2015
(86) PCT No.: PCT/US2015/021406

§ 371 Date: Sep. 23, 2016

Related U.S. Application Data
(60) Provisional application No. 61/970,493, filed on Mar. 26, 2014.
(60) Provisional application No. 61/984,905, filed on Apr. 28, 2014.

(51) Int. Cl. C08G 18/32; B29C 67/24; C08G 18/42; B29C 45/00; C08G 18/76; C08G 18/48

(52) U.S. Cl. CPC C08G 18/3206; C08G 18/76; C08G 18/48; C08G 18/4238; C08G 18/4277; B29C 45/0001; B29C 67/246; C08G 2101/0008

(57) ABSTRACT

The compositions described herein provide flexible polyurethane injection molded foam made from the reaction product of at least one polyol, at least one isocyanate, and at least one chain extender, where the polyurethane has: (a) a weight average molecular weight of 120,000 to 500,000, and (b) a dispersity (Mw/Mn) of 1.85 to 2.51. The compositions further include superior foams where the flexible polyurethane injection molded foam has: a vertical rebound, as measured by ASTM D2632, of at least 30%; a compression set at room temperature, as measured by ASTM D395, of no more than 25%; a compression set at 50 C, as measured by ASTM D395, of no more than 50%; and an Asker C hardness, as measured by ASTM D2240, of 40 to 65. Also provided are process of making the same and articles made from the same.

The compositions described herein provide flexible polyurethane injection molded foam made from the reaction product of at least one polyol, at least one isocyanate, and at least one chain extender, where the polyurethane has: (a) a weight average molecular weight of 120,000 to 500,000, and (b) a dispersity (M_{w}/Mₙ) of 1.85 to 2.51. The compositions further include superior foams where the flexible polyurethane injection molded foam has: a vertical rebound, as measured by ASTM D2632, of at least 30%; a compression set at room temperature, as measured by ASTM D395, of no more than 25%; a compression set at 50° C., as measured by ASTM D395, of no more than 50%; and an Asker C hardness, as measured by ASTM D2240, of from 30 to 65, or from 40 to 65, or from 44 to 65. Also provided are processes of making the same and articles made from the same.

### BACKGROUND

This technology relates to flexible polyurethane injection molded foam, processes of making the same, and articles made from the same.

Flexible polyurethane foams are well recognized articles of commerce. Flexible polyurethane foams are used in a wide variety of applications, ranging from cushioning (such as mattresses, pillows and seat cushions) to packaging to thermal insulation. Polyurethane foams insulate, float, cushion, glue, clothe and absorb sound, among many other applications. Polyurethanes, defined as polymeric substances having multiple urethane linkages, are a large family of polymers with widely ranging properties and uses. The types and properties of polyurethanes are so varied that the Alliance for the Polyurethanes Industry (Arlington, Va.) has dubbed them the “erector set” of the plastics industry. Types of polyurethanes include rigid and flexible foams; thermoplastic polyurethane; and other miscellaneous types, such as coatings, adhesives, sealants and elastomers. Flexible foams (e.g., that found in most car seat cushions) are generally open-celled materials, while rigid foams (e.g., building insulation) usually have a high proportion of closed cells.

While there is growing interest in using flexible polyurethane foams in an ever increasing range of applications, it can be difficult to find polyurethane materials that foam well, and even once such materials are identified it can be very difficult to find polyurethane materials that when foamed provide the physical properties needed for specific applications.

Therefore, there is a need for flexible polyurethane injection molded foams which have acceptable foam processing properties, and in some embodiments, acceptable balances between the properties of vertical rebound, compression set at room temperature, compression set at elevated temperature and hardness.

### SUMMARY

The disclosed technology provides a flexible polyurethane injection molded foam that includes the reaction product of a reaction system, wherein the reaction system includes: (i) at least one polyol, (ii) at least one isocyanate, and (iii) at least one chain extender; where the polyurethane has: (a) a weight average molecular weight of 120,000 to 500,000, and (b) a dispersity (M_{w}/Mₙ) of 1.85 to 2.51. The polyurethane formed by the described reaction system, and which has the described properties, is well suited to be processed into a flexible polyurethane foam.

The disclosed technology provides for the described flexible polyurethane injection molded foams where the foam has: (i) a peak temperature of crystallization, as measured by DSC, between 40° C. and 205° C.; (ii) a peak temperature of melting, as measured by DSC, between 106° C. and 206° C.; (iii) a difference between the peak temperature of melting and the peak temperature of crystallization, each as measured by DSC, between 1 degree and 137 degrees; and (iv) a melt strength, as measured by Rheoten, between 0.003 and 0.6 N.

The disclosed technology provides for the described flexible polyurethane injection molded foams where the foam has: (i) a vertical rebound, as measured by ASTM D2632, of at least 30%; (ii) a compression set at room temperature, as measured by ASTM D395, of no more than 25%; (iii) a compression set at 50° C., as measured by ASTM D395, of no more than 50%; and (iv) an Asker C hardness, as measured by ASTM D2240, of from 30 to 65, or from 40 to 65 or from 44 to 65. The polyurethane formed by the described reaction system, and which has the described properties, is well suited to be processed into a flexible polyurethane foam and provides a foam with superior performance properties.

The disclosed technology provides for the described flexible polyurethane injection molded foams where the reaction system includes one or more blowing agents, one or more cell opening surfactants, or any combination thereof.

The disclosed technology provides for the described flexible polyurethane injection molded foams where the flexible polyurethane injection molded foam reaction system further includes a blowing agent and/or a cell opening surfactant. That is the blowing agent and/or a cell opening surfactant can be added after the formation of the polyurethane composition produced from the reaction system.

The disclosed technology provides for the described flexible polyurethane injection molded foams where said blowing agent includes water.

The disclosed technology provides for the described flexible polyurethane injection molded foams where the blowing agent includes: a linear, branched or cyclic C₁-C₆ hydrocarbon; a linear, branched or cyclic C₁-C₆ (hydro)fluorocarbon; N₂; O₂; argon; CO₂; or any combination thereof.

The disclosed technology provides for the described flexible polyurethane injection molded foams where the cell opening surfactant comprises one or more silicones, siloxane copolymers, non-siloxane co-polymers, non-silicones, or any combination thereof.

The disclosed technology provides for the described flexible polyurethane injection molded foams where the polyurethane has a hard segment content of from 23.5 to 45.0 percent by weight and wherein the polyol component comprises a polyether polyol.

The disclosed technology provides for the described flexible polyurethane injection molded foams where the polyurethane has a hard segment content of from 24 to 30 percent by weight, and wherein the polyol component comprises a polyester polyol.

The disclosed technology provides for the flexible polyurethane injection molded foams where the polyurethane has a hard segment content of greater than 30 percent by weight, and wherein the polyol component comprises a polycaprolactone polyol.

The disclosed technology provides for the described flexible polyurethane injection molded foams where the chain extender includes 1,4-butandiol, benzene glycol, or any combination thereof.

The disclosed technology provides for the described flexible polyurethane injection molded foams where the polyol comprises polytetramethylene ether glycol.

The disclosed technology also provides a process of making any of the flexible polyurethane injection molded foams described herein. The disclosed process includes the steps of: (I) mixing (i) at least one polyol, (ii) at least one isocyanate, (iii) at least one chain extender, (iv) a blowing agent, and optionally (v) one or more crosslinking agents, resulting in a reaction system; and (II) injection molding the mixture in such a way that the components interact to form a foam, where the polyurethane has: (a) a weight average molecular weight of 120,000 to 500,000, and (b) a dispersity (M_{w}/Mₙ) of 1.85 to 2.51.

The disclosed technology also provides a process of making any of the flexible polyurethane injection molded foams described herein where the process includes the steps of: (I) mixing (i) at least one polyol, (ii) at least one isocyanate, (iii) at least one chain extender, and optionally (iv) one or more crosslinking agents, resulting in a reaction system that provides a polyurethane composition; (II) mixing the polyurethane composition and a blowing agent, resulting in a foaming mixture; and (III) injection molding the foaming mixture in such a way that the components interact to form a foam, where the polyurethane has: (a) a weight average molecular weight of 120,000 to 500,000, and (b) a dispersity (M_{w}/Mₙ) of 1.85 to 2.51. Again, the blowing agent and/or a cell opening surfactant can be added after the formation of the polyurethane composition produced from the reaction system.

The disclosed technology provides for the described process where the step of injecting (and optionally curing) the reaction system to the flexible polyurethane injection molded foam takes place in a mold.

The disclosed technology provides for the described process where the reaction system is foamed free-risen.

The disclosed technology provides for the described process where the reaction system is foamed closed mold.

### DETAILED DESCRIPTION

Various preferred features and embodiments will be described below by way of non-limiting illustration.

The disclosed technology provides a flexible polyurethane injection molded foams that includes the reaction product of a reaction system, wherein the reaction system includes: (i) at least one polyol, (ii) at least one isocyanate, and (iii) at least one chain extender; where the polyurethane has: (a) a weight average molecular weight of 120,000 to 500,000, and (b) a dispersity (M_{w}/Mₙ) of 1.85 to 2.51.

The polyurethane formed by the described reaction system, and which has the described properties, is well suited to be processed into a flexible polyurethane foam. Many polyurethanes are not so well suited and form poor foams, or even no foams at all. In some embodiments, the flexible polyurethane foams described herein may include two or more polyurethanes made from two or more reaction systems. The described reaction system and resulting polyurethane may of course only apply to one of the polyurethanes present in such systems, but in some embodiments they could apply to both independently. Further, it is noted that crosslinking agents and similar materials may be used with the polyurethanes described herein, however, the properties of the polyurethanes, including their weight average molecular weight and dispersity, are in regards to the materials before any crosslinking agents or similar materials are applied, unless otherwise noted.

The disclosed technology provides for the described flexible polyurethane injection molded foams where the foam has: (i) a peak temperature of crystallization, as measured by DSC, between 40° C. and 205° C., or even 42 to 204, 70 to 120, 78 to 100, or even 79 to 100° C.; (ii) a peak temperature of melting, as measured by DSC, between 106° C. and 206° C., or even from 132 to 206, 135 to 206, 138 to 182, or even 138 to 168° C.; (iii) a difference between the peak temperature of melting and the peak temperature of crystallization, each as measured by DSC, between 1 degree and 137 degrees, or even from 1.9 to 105, 24 to 104, or even 48 to 70 degrees; and (iv) a melt strength, as measured by Rheoten, between 0.003 and 0.6 N, or even from 0.003 to 0.6, 0.004 to 0.6, 0.04 to 0.5, or even 0.04 to 0.2 N.

In some embodiments, the flexible polyurethane injection molded foams described herein, have: a vertical rebound, as measured by ASTM D2632, of at least 30%; a compression set at room temperature, as measured by ASTM D395, of no more than 25%; a compression set at 50° C., as measured by ASTM D395, of no more than 50%; and an Asker C hardness, as measured by ASTM D2240, of from 30 to 65, or from 40 to 65 or from 44 to 65.

In further embodiments, some of the flexible polyurethane injection molded foams described herein have: a hard segment content of from 23.5 to 45.0 percent by weight or even from 23.9 to 43.3, or from 23.9 to 40.3. or even from 23.9 to 27.8; and the polyol component includes a polyether polyol which in some embodiments includes PTMEG. The hard segment content of a polyurethane is the total weight percent content of chain extender and isocyanate used to make the polyurethane, generally excluding any components that do not participate in the reaction that forms the polyurethane.

In still further embodiments, some of the flexible polyurethane injection molded foams described herein have: a hard segment content of from 24 to 30 percent by weight, and the polyol component includes a polyester polyol.

In still further embodiments, some of the flexible polyurethane injection molded foams described herein have: a hard segment content of more than 30 percent by weight or even from 30 to 50 or from 40 to 50 percent by weight; and the polyol component includes a polycaprolactone polyol.

Such flexible polyurethane injection molded foams as those described above provide not only good foam processing properties but also a good balance of physical properties making them particularly well suited for a variety of applications, including but not limited to shoe soles, mid soles and in soles in particular.

### The Polyol Component

The flexible polyurethane injection molded foams are made using a reaction system that includes a polyol. Suitable polyols include polyether polyols, polyester polyols, polycarbonate polyols, polysiloxane polyols, and combinations thereof.

Suitable polyols, which may also be described as hydroxyl terminated intermediates, when present, may include one or more hydroxyl terminated polyesters, one or more hydroxyl terminated polyethers, one or more hydroxyl terminated polycarbonates, one or more hydroxyl terminated polysiloxanes, or mixtures thereof. Suitable polyols may also include amine terminated polyols.

Suitable hydroxyl terminated polyester intermediates include linear polyesters having a number average molecular weight (Mₙ) of from about 500 to about 10,000, from about 700 to about 5,000, or from about 700 to about 4,000, and generally have an acid number less than 1.3 or less than 0.5. The molecular weight is determined by assay of the terminal functional groups and is related to the number average molecular weight. The polyester intermediates may be produced by (1) an esterification reaction of one or more glycols with one or more dicarboxylic acids or anhydrides or (2) by transesterification reaction, i.e., the reaction of one or more glycols with esters of dicarboxylic acids. Mole ratios generally in excess of more than one mole of glycol to acid are preferred so as to obtain linear chains having a preponderance of terminal hydroxyl groups. Suitable polyester intermediates also include various lactones such as polycaprolactone typically made from 8-caprolactone and a bifunctional initiator such as diethylene glycol. The dicarboxylic acids of the desired polyester can be aliphatic, cycloaliphatic, aromatic, or combinations thereof. Suitable dicarboxylic acids which may be used alone or in mixtures generally have a total of from 4 to 15 carbon atoms and include: succinic, glutaric, adipic, pimelic, suberic, azelaic, sebacic, dodecanedioic, isophthalic, terephthalic, cyclohexane dicarboxylic, dimer (C36 dimer acid) and the like. Anhydrides of the above dicarboxylic acids such as phthalic anhydride, tetrahydrophthalic anhydride, or the like, can also be used. Adipic acid is a preferred acid. The glycols which are reacted to form a desirable polyester intermediate can be aliphatic, aromatic, or combinations thereof, including any of the glycols described above in the chain extender section, and have a total of from 2 to 20 or from 2 to 12 carbon atoms. Suitable examples include ethylene glycol (EG), 1,2-propanediol, 1,3-propanediol, 1,3-butanediol, 1,4-butanediol (BDO), 1,5-pentanediol, 1,6-hexanediol (HDO), 2,2-dimethyl-1,3-propanediol, 1,4-cyclohexanedimethanol, decamethylene glycol, dodecamethylene glycol, and mixtures thereof.

The polyol component may also include one or more polycaprolactone polyester polyols. The polycaprolactone polyester polyols useful in the technology described herein include polyester diols derived from caprolactone monomers. The polycaprolactone polyester polyols are terminated by primary hydroxyl groups. Suitable polycaprolactone polyester polyols may be made from 8-caprolactone and a bifunctional initiator such as diethylene glycol, 1,4-butanediol, or any of the other glycols and/or diols listed herein. In some embodiments, the polycaprolactone polyester polyols are linear polyester diols derived from caprolactone monomers (CAPA).

Useful examples include CAPA™ 2202A, a 2000 number average molecular weight (Mn) linear polyester diol, and CAPA™ 2302A, a 3000 Mn linear polyester diol, both of which are commercially available from Perstorp Polyols Inc. These materials may also be described as polymers of 2-oxepanone and 1,4-butanediol.

The polycaprolactone polyester polyols may be prepared from 2-oxepanone and a diol, where the diol may be 1,4-butanediol, diethylene glycol, monoethylene glycol, 1,6-hexanediol, 2,2-dimethyl-1,3-propanediol, or any combination thereof. In some embodiments, the diol used to prepare the polycaprolactone polyester polyol is linear. In some embodiments, the polycaprolactone polyester polyol is prepared from 1,4-butanediol. In some embodiments, the polycaprolactone polyester polyol has a number average molecular weight from 500 to 10,000, or from 500 to 5,000, or from 1,000 or even 2,000 to 4,000 or even 3000.

Suitable hydroxyl terminated polyether intermediates include polyether polyols derived from a diol or polyol having a total of from 2 to 15 carbon atoms, in some embodiments an alkyl diol or glycol which is reacted with an ether comprising an alkylene oxide having from 2 to 6 carbon atoms, typically ethylene oxide or propylene oxide or mixtures thereof. For example, hydroxyl functional polyether can be produced by first reacting propylene glycol with propylene oxide followed by subsequent reaction with ethylene oxide. Primary hydroxyl groups resulting from ethylene oxide are more reactive than secondary hydroxyl groups and thus are preferred. Useful commercial polyether polyols include poly(ethylene glycol) comprising ethylene oxide reacted with ethylene glycol, polypropylene glycol) comprising propylene oxide reacted with propylene glycol, poly(tetramethylene ether glycol) comprising water reacted with tetrahydrofuran which can also be described as polymerized tetrahydrofuran, and which is commonly referred to as PTMEG. In some embodiments, the polyether intermediate includes PTMEG. Suitable polyether polyols also include polyamide adducts of an alkylene oxide and can include, for example, ethylenediamine adduct comprising the reaction product of ethylenediamine and propylene oxide, diethylenetriamine adduct comprising the reaction product of diethylenetriamine with propylene oxide, and similar polyamide type polyether polyols. Copolyethers can also be utilized in the described compositions. Typical copolyethers include the reaction product of THF and ethylene oxide or THF and propylene oxide. These are available from BASF as PolyTHF® B, a block copolymer, and poly THF® R, a random copolymer. The various polyether intermediates generally have a number average molecular weight (Mₙ) as determined by assay of the terminal functional groups which is an average molecular weight greater than about 700, such as from about 700 to about 10,000, from about 1,000 to about 5,000, or from about 1,000 to about 2,500. In some embodiments, the polyether intermediate includes a blend of two or more different molecular weight polyethers, such as a blend of 2,000 Mₙ and 1000 Mₙ PTMEG.

Suitable hydroxyl terminated polycarbonates include those prepared by reacting a glycol with a carbonate. U.S. Pat. No. 4,131,731 is hereby incorporated by reference for its disclosure of hydroxyl terminated polycarbonates and their preparation. Such polycarbonates are linear and have terminal hydroxyl groups with essential exclusion of other terminal groups. The essential reactants are glycols and carbonates. Suitable glycols are selected from cycloaliphatic and aliphatic diols containing 4 to 40, and or even 4 to 12 carbon atoms, and from polyoxyalkylene glycols containing 2 to 20 alkoxy groups per molecule with each alkoxy group containing 2 to 4 carbon atoms. Suitable diols include aliphatic diols containing 4 to 12 carbon atoms such as 1,4-butanediol, 1,5-pentanediol, neopentyl glycol, 1,6-hexanediol, 2,2,4-trimethyl-1,6-hexanediol, 1,10-decanediol, hydrogenated dilinoleylglycol, hydrogenated dioleylglycol, 3-methyl-1,5-pentanediol; and cycloaliphatic diols such as 1,3-cyclohexanediol, 1,4-dimethylolcyclohexane, 1,4-cyclohexanediol-, 1,3-dimethylolcyclohexane-, 1,4-endomethylene-2-hydroxy-5-hydroxymethyl cyclohexane, and polyalkylene glycols. The diols used in the reaction may be a single diol or a mixture of diols depending on the properties desired in the finished product. Polycarbonate intermediates which are hydroxyl terminated are generally those known to the art and in the literature. Suitable carbonates are selected from alkylene carbonates composed of a 5 to 7 member ring. Suitable carbonates for use herein include ethylene carbonate, trimethylene carbonate, tetramethylene carbonate, 1,2-propylene carbonate, 1,2-butylene carbonate, 2,3-butylene carbonate, 1,2-ethylene carbonate, 1,3-pentylene carbonate, 1,4-pentylene carbonate, 2,3-pentylene carbonate, and 2,4-pentylene carbonate. Also, suitable herein are dialkylcarbonates, cycloaliphatic carbonates, and diarylcarbonates. The dialkylcarbonates can contain 2 to 5 carbon atoms in each alkyl group and specific examples thereof are diethylcarbonate and dipropylcarbonate. Cycloaliphatic carbonates, especially dicycloaliphatic carbonates, can contain 4 to 7 carbon atoms in each cyclic structure, and there can be one or two of such structures. When one group is cycloaliphatic, the other can be either alkyl or aryl. On the other hand, if one group is aryl, the other can be alkyl or cycloaliphatic. Examples of suitable diarylcarbonates, which can contain 6 to 20 carbon atoms in each aryl group, are diphenylcarbonate, ditolylcarbonate, and dinaphthylcarbonate.

Suitable polysiloxane polyols include alpha-omega-hydroxyl or amine or carboxylic acid or thiol or epoxy terminated polysiloxanes. Examples include poly(dimethysiloxane) terminated with a hydroxyl or amine or carboxylic acid or thiol or epoxy group. In some embodiments, the polysiloxane polyols are hydroxyl terminated polysiloxanes. In some embodiments, the polysiloxane polyols have a number-average molecular weight in the range from 300 to 5,000, or from 400 to 3,000.

Polysiloxane polyols may be obtained by the dehydrogenation reaction between a polysiloxane hydride and an aliphatic polyhydric alcohol or polyoxyalkylene alcohol to introduce the alcoholic hydroxy groups onto the polysiloxane backbone.

In some embodiments, the polysiloxanes may be represented by one or more compounds having the following formula:

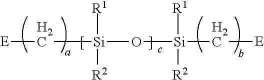

in which: each R¹ and R² are independently a 1 to 4 carbon atom alkyl group, a benzyl, or a phenyl group; each E is OH or NHR³ where R³ is hydrogen, a 1 to 6 carbon atoms alkyl group, or a 5 to 8 carbon atoms cyclo-alkyl group; a and b are each independently an integer from 2 to 8; c is an integer from 3 to 50. In amino-containing polysiloxanes, at least one of the E groups is NHR³. In the hydroxyl-containing polysiloxanes, at least one of the E groups is OH. In some embodiments, both R¹ and R² are methyl groups.

Suitable examples include alpha-omega-hydroxypropyl terminated poly(dimethysiloxane) and alpha-omega-amino propyl terminated poly(dimethysiloxane), both of which are commercially available materials. Further examples include copolymers of the poly(dimethysiloxane) materials with a poly(alkylene oxide).

The polyol component, when present, may include poly(ethylene glycol), poly(tetramethylene ether glycol), poly(trimethylene oxide), ethylene oxide capped polypropylene glycol), poly(butylene adipate), poly(ethylene adipate), poly(hexamethylene adipate), poly(tetramethylene-co-hexamethylene adipate), poly(3-methyl-1,5-pentamethylene adipate), polycaprolactone diol, poly(hexamethylene carbonate) glycol, poly(pentamethylene carbonate) glycol, poly(trimethylene carbonate) glycol, dimer fatty acid based polyester polyols, vegetable oil based polyols, or any combination thereof. Suitable dimerates, prepared from dimer acid, are also suitable.

Examples of dimer fatty acids that may be used to prepare suitable polyester polyols include Priplast™ polyester glycols/polyols commercially available from Croda and Radia® polyester glycols commercially available from Oleon.

In some embodiments, the polyol component includes a polyether polyol, a polycarbonate polyol, a polycaprolactone polyol, or any combination thereof.

In some embodiments, the polyol component includes a polyether polyol. In some embodiments, the polyol component is essentially free of or even completely free of polyester polyols. In some embodiments, the polyol component used to prepare the TPU is substantially free of, or even completely free of polysiloxanes.

In some embodiments, the polyol component includes ethylene oxide, propylene oxide, butylene oxide, styrene oxide, poly(tetramethylene ether glycol), poly(propylene glycol), poly(ethylene glycol), copolymers of poly(ethylene glycol) and poly(propylene glycol), epichlorohydrin, and the like, or combinations thereof. In some embodiments, the polyol component includes poly(tetramethylene ether glycol).

In some embodiments, the polyol has a number average molecular weight of at least 900. In other embodiments, the polyol has a number average molecular weight of at least 900, 1,000, 1,500, 1,750, and/or a number average molecular weight up to 5,000, 4,000, 3,000, 2,500, or even 2,000.

In some embodiments, the polyol component comprises a polyether polyol, and in some embodiments that polyether polyol is poly(tetramethylene ether glycol), which is also referred to as PTMEG.

In some embodiments, the polyol component comprises a polyester polyol, and in some embodiments that polyester polyol is the reaction of a diol and adipic acid to form an alkyl adipate. In some embodiments, the polyester polyol is polybutylene adipate, polyethylene glycol adipate, an adipate made from a mixture of butanediol and ethylene glycol, or a combination thereof.

In some embodiments, the polyol component comprises a polycaprolactone polyol. In some embodiments the polycaprolactone polyester polyols are linear polyester diols derived from caprolactone monomers.

### The Polyisocyanate

The flexible polyurethane injection molded foams are made using a reaction system that includes an isocyanate. Suitable isocyanates polyisocyanate, which may include one or more polyisocyanates. In some embodiments, the polyisocyanate component includes one or more diisocyanates.

Suitable polyisocyanates include aromatic diisocyanates, aliphatic diisocyanates, or combinations thereof. In some embodiments, the polyisocyanate component includes one or more aromatic diisocyanates. In some embodiments, the polyisocyanate component is essentially free of, or even completely free of, aliphatic diisocyanates.

Examples of useful polyisocyanates include aromatic diisocyanates such as 4,4″-methylenebis(phenyl isocyanate) (MDI), m-xylene diisocyanate (XDI), phenylene-1,4-diisocyanate, naphthalene-1,5-diisocyanate, and toluene diisocyanate (TDI); as well as aliphatic diisocyanates such as isophorone diisocyanate (IPDI), 1,4-cyclohexyl diisocyanate (CHDI), decane-1,10-diisocyanate, lysine diisocyanate (LDI), 1,4-butane diisocyanate (BDI), isophorone diisocyanate (PDI), 3,3′-Dimethyl-4,4′-biphenylene diisocyanate (TODI), 1,5-naphthalene diisocyanate (NDI), and dicyclohexylmethane-4,4′-diisocyanate (H12MDI). Mixtures of two or more polyisocyanates may be used. In some embodiments, the polyisocyanate is MDI and/or H12MDI. In some embodiments, the polyisocyanate includes MDI. In some embodiments, the polyisocyanate may include H12MDI. In some embodiments, the polyisocyanate component is essentially free of, or even completely free of, hexamethylene diisocyanate (HDI).

In some embodiments, the thermoplastic polyurethane is prepared with a polyisocyanate component that includes MDI. In some embodiments, the thermoplastic polyurethane is prepared with a polyisocyanate component that consists essentially of MDI. In some embodiments, the thermoplastic polyurethane is prepared with a polyisocyanate component that consists of MDI.

In some embodiments, the thermoplastic polyurethane is prepared with a polyisocyanate component that includes (or consists essentially of, or even consists of) MDI and at least one of H12MDI, HDI, TDI, IPDI, LDI, BDI, PDI, CHDI, TODI, and NDI. In some embodiments, the polyisocyanate includes MDI, H12MDI, HDI, or any combination thereof.

### The Chain Extender

The flexible polyurethane injection molded foams are made using a reaction system that includes a chain extender. Suitable chain extenders include diols, diamines, and combinations thereof.

Suitable chain extenders include relatively small polyhydroxy compounds, for example lower aliphatic or short chain glycols having from 2 to 20, or 2 to 12, or 2 to 10 carbon atoms. Suitable examples include ethylene glycol, diethylene glycol, propylene glycol, dipropylene glycol, 1,4-butanediol (BDO), 1,6-hexanediol (HDO), 1,3-butanediol, 1,5-pentanediol, neopentylglycol, 1,4-cyclohexanedimethanol (CHDM), 2,2-bis[4-(2-hydroxyethoxy) pheny]lpropane (HEPP), hexamethylenediol, heptanediol, nonanediol, dodecanediol, 3-methyl-1,5-pentanediol, ethylenediamine, butanediamine, hexamethylenediamine, and hydroxyethyl resorcinol (HER), and the like, as well as mixtures thereof. In some embodiments, the chain extender includes BDO, HDO, 3-methyl-1,5-pentanediol, or a combination thereof. In some embodiments, the chain extender includes BDO. Other glycols, such as aromatic glycols could be used, but in some embodiments the polyurethane described herein, which may also be described as thermoplastic polyurethane (TPU), are essentially free of or even completely free of such materials.

In some embodiments, the chain extender used to prepare the TPU is substantially free of, or even completely free of, 1,6-hexanediol. In some embodiments, the chain extender used to prepare the TPU includes a cyclic chain extender. Suitable examples include CHDM, HEPP, HER, and combinations thereof. In some embodiments, the chain extender used to prepare the TPU includes an aromatic cyclic chain extender, for example HEPP, HER, or a combination thereof. In some embodiments, the chain extender used to prepare the TPU includes an aliphatic cyclic chain extender, for example CHDM. In some embodiments, the chain extender used to prepare the TPU is substantially free of, or even completely free of aromatic chain extenders, for example aromatic cyclic chain extenders. In some embodiments, the chain extender used to prepare the TPU is substantially free of, or even completely free of polysiloxanes.

In some embodiments, the chain extender component includes 1,4-butanediol, 2-ethyl-1,3-hexanediol, 2,2,4-trimethyl pentane-1,3-diol, 1,6-hexanediol, 1,4-cyclohexane dimethylol, 1,3-propanediol, 3-methyl-1,5-pentanediol, butyl ethyl propane diol (BEPD), or combinations thereof. In some embodiments, the chain extender component includes 1,4-butanediol, 3-methyl-1,5-pentanediol or combinations thereof. In some embodiments, the chain extender component includes 1,4-butanediol.

In some embodiments, the chain extender component comprises a linear alkylene diol. In some embodiments, the chain extender component comprises 1,4-butanediol, dipropylene glycol, or a combination of the two. In some embodiments, the chain extender component comprises 1,4-butanediol.

In some embodiments, aromatic glycols are used as the chain extender and are often the choice for high heat applications. Benzene glycol (HQEE) and xylylene glycols are suitable chain extenders. Xylylene glycol is a mixture of 1,4-di(hydroxymethyl) benzene and 1,2-di(hydroxymethyl) benzene. Benzene glycol is one suitable aromatic chain extender and specifically includes hydroquinone, i.e., bis(beta-hydroxyethyl) ether also known as 1,4-di(2-hydroxyethoxy) benzene; resorcinol, i.e., bis(beta-hydroxyethyl) ether also known as 1,3-di(2-hydroxyethyl) benzene; catechol, i.e., bis(beta-hydroxyethyl) ether also known as 1,2-di(2-hydroxyethoxy) benzene; and combinations thereof.

Suitable chain extenders also include diamine chain extenders. Suitable diamine chain extenders can be aliphatic or aromatic in nature, such as alkylenediamines of from 1-30 carbon atoms (e.g., ethylenediamine, butanediamine, hexamethylenediamine).

In some embodiments, the mole ratio of the chain extender to the polyol is greater than 1.5. In other embodiments, the mole ratio of the chain extender to the polyol is at least (or greater than) 1.5, 2.0, 3.5, 3.7, or even 3.8 and/or the mole ratio of the chain extender to the polyol may go up to 5.0, or even 4.0.

In some embodiments, the chain extender component includes HQEE, 1,4-butanediol, 1,6-hexanediol, 1-12-dodecanediol, or any combination thereof. In some embodiments, the chain extender component includes HQEE, 1,4-butanediol, or any combination thereof.

### Additional Items

The reaction system and/or polyurethane composition used to prepare the described flexible polyurethane injection molded foams may further include a blowing agent and/or a cell opening surfactant. One or more other materials and/or additives may also be present in the reaction system and/or mixed with the polyurethane produced by the reaction system.

In some embodiments, the blowing agent includes water. Suitable blowing agents include: linear, branched or cyclic C₁-C₆ hydrocarbons; a linear, branched or cyclic C₁-C₆ (hydro)fluorocarbon; N₂; O₂; argon; CO₂; or any combination thereof.

Suitable cell opening surfactant includes one or more silicones, siloxane copolymers, non-siloxane co-polymers, non-silicones, or any combination thereof.

Suitable blowing agent include chlorofluorocarbons (CFC's), hydrochlorofluorocarbons (HCFC's), hydrofluorocarbons (HFC's), hydrofluoro ethers (HFE's), hydrofluoro olefins (HFO's), methylene chloride, hydrocarbons, alkyl alkanoates, or other organic compounds.

The concentration of blowing agent(s) in the foam and/or reaction system may be from about 0.5% by weight to about 15% by weight, or about 0.5% by weight to about 12% by weight, or even about 2% by weight to about 10% by weight. The surfactant can make up less than about 4% by weight, or 0.75% by weight, of the foam and/or reaction system.

The cell opening surfactant promotes cell opening of the foam and results in a foam that is at least 50% open cell. Examples of cell opening surfactants include silicones and siloxane copolymers, such as Niax L-6164, DC-5160, DC-5125, DC 5241, B-8021, L-620, L-6202 (Degussa/Goldschmidt Chemical Corp.; Mapleton, Ill.); L-620 (Union Carbide; Houston, Tex.); L-6202 and Y-10390 (Air Products; Allentown, Pa.) or non-siloxane copolymers such, as Ortegol® 500 or Ortegol® 501 and non-silicones.

The composition may further comprise a surfactant that promotes cell closing. Examples of cell closing surfactants include silicones and siloxane copolymers, such as B8404, DC-193, DC-5598, L5440, L6900 and Silstab 2000, and non-silicones.

The concentration of cell opening surfactant in the foam and/or reaction system can be from about 0.10% to about 4.0% by weight, or about 0.10% to about 1.0% by weight, or even from about 0.20% to about 0.70% by weight. If a cell closing surfactant is present, it typically makes up from about 0.10% to about 4.0% by weight, or about 0.50% to about 3.0% by weight. One skilled in the art can adjust the concentrations of the cell opening surfactant and the cell closing surfactant in order to obtain the desired density, compressive strength, and buoyancy of the resultant foam.

The reaction system used to prepare the described flexible polyurethane injection molded foams may further include a nucleating agent. Nucleating agents serve primarily to increase cell count and decrease cell size in the foam, and may be used in an amount of about 0.1 to about 10 parts by weight per 100 parts by weight of the resin. Suitable nucleating agents include talc, sodium bicarbonate-citric acid mixtures, calcium silicate, carbon dioxide, or any combination thereof.

As noted above, the blowing agents and/or a cell opening surfactants which may be utilized in the described foam composition may be added to the reaction system and be present during the reaction that forms the polyurethane, or may be added to the polyurethane that results from the reaction system. In such embodiments the polyurethane may be formed in a separate step. The blowing agents and/or cell opening surfactants may be added to the polyurethane. In some embodiments the agents and/or cell opening surfactants are added to a polyurethane melt just before injection into the mold. Unless otherwise noted, the additional components described below may also be added to the reaction system or to the polyurethane the results from the system.

The foam compositions described herein may contain one or more additional components. These additional components include other polymeric materials that may be blended with the TPU described herein. These additional components include one or more additives that may be added to the polymer composition, or blend, to impact the properties of the composition.

The foam and/or polyurethane described herein may also be blended with one or more other polymers. The polymers with which the TPU described herein may be blended are not overly limited. In some embodiments, the described compositions include a two or more of the described TPU materials. In some embodiments, the compositions include at least one of the described TPU materials and at least one other polymer, which is not one of the described TPU materials.

Polymers that may be used in combination with the TPU materials described herein also include more conventional TPU materials such as non-caprolactone polyester-based TPU, polyether-based TPU, or TPU containing both non-caprolactone polyester and polyether groups. Other suitable materials that may be blended with the TPU materials described herein include polycarbonates, polyolefins, styrenic polymers, acrylic polymers, polyoxymethylene polymers, polyamides, polyphenylene oxides, polyphenylene sulfides, polyvinylchlorides, chlorinated polyvinylchlorides, polylactic acids, or combinations thereof.

Polymers for use in the blends described herein include homopolymers and copolymers. Suitable examples include: (i) a polyolefin (PO), such as polyethylene (PE), polypropylene (PP), polybutene, ethylene propylene rubber (EPR), polyoxyethylene (POE), cyclic olefin copolymer (COC), or combinations thereof; (ii) a styrenic, such as polystyrene (PS), acrylonitrile butadiene styrene (ABS), styrene acrylonitrile (SAN), styrene butadiene rubber (SBR or HIPS), polyalphamethylstyrene, styrene maleic anhydride (SMA), styrene-butadiene copolymer (SBC) (such as styrene-butadiene-styrene copolymer (SBS) and styrene-ethylene/butadiene-styrene copolymer (SEBS)), styrene-ethylene/propylene-styrene copolymer (SEPS), styrene butadiene latex (SBL), SAN modified with ethylene propylene diene monomer (EPDM) and/or acrylic elastomers (for example, PS-SBR copolymers), or combinations thereof; (iii) a thermoplastic polyurethane (TPU) other than those described above; (iv) a polyamide, such as Nylon™, including polyamide 6,6 (PA66), polyamide 1,1 (PA11), polyamide 1,2 (PA12), a copolyamide (COPA), or combinations thereof; (v) an acrylic polymer, such as polymethyl acrylate, polymethylmethacrylate, a methyl methacrylate styrene (MS) copolymer, or combinations thereof; (vi) a polyvinylchloride (PVC), a chlorinated polyvinylchloride (CPVC), or combinations thereof; (vii) a polyoxyemethylene, such as polyacetal; (viii) a polyester, such as polyethylene terephthalate (PET), polybutylene terephthalate (PBT), copolyesters and/or polyester elastomers (COPE) including polyether-ester block copolymers such as glycol modified polyethylene terephthalate (PETG), polylactic acid (PLA), polyglycolic acid (PGA), copolymers of PLA and PGA, or combinations thereof; (ix) a polycarbonate (PC), a polyphenylene sulfide (PPS), a polyphenylene oxide (PPO), or combinations thereof; or combinations thereof.

In some embodiments, these blends include one or more additional polymeric materials selected from groups (i), (iii), (vii), (viii), or some combination thereof. In some embodiments, these blends include one or more additional polymeric materials selected from group (i). In some embodiments, these blends include one or more additional polymeric materials selected from group (iii). In some embodiments, these blends include one or more additional polymeric materials selected from group (vii). In some embodiments, these blends include one or more additional polymeric materials selected from group (viii).

The additional additives suitable for use in the TPU compositions described herein are not overly limited. Suitable additives include pigments, UV stabilizers, UV absorbers, antioxidants, lubricity agents, heat stabilizers, hydrolysis stabilizers, cross-linking activators, flame retardants, layered silicates, fillers, colorants, reinforcing agents, adhesion mediators, impact strength modifiers, antimicrobials, and any combination thereof.

In some embodiments, the additional component is a flame retardant. Suitable flame retardants are not overly limited and may include a boron phosphate flame retardant, a magnesium oxide, a dipentaerythritol, a polytetrafluoroethylene (PTFE) polymer, or any combination thereof. In some embodiments, this flame retardant may include a boron phosphate flame retardant, a magnesium oxide, a dipentaerythritol, or any combination thereof. A suitable example of a boron phosphate flame retardant is BUDIT 326, commercially available from Budenheim USA, Inc. When present, the flame retardant component may be present in an amount from 0 to 10 weight percent of the overall TPU composition, in other embodiments from 0.5 to 10, or from 1 to 10, or from 0.5 or 1 to 5, or from 0.5 to 3, or even from 1 to 3 weight percent of the overall TPU composition.

The TPU compositions described herein may also include additional additives, which may be referred to as a stabilizer. The stabilizers may include antioxidants such as phenolics, phosphites, thioesters, and amines, light stabilizers such as hindered amine light stabilizers and benzothiazole UV absorbers, and other process stabilizers and combinations thereof. In one embodiment, the preferred stabilizer is Irganox® 1010 from BASF and Naugard® 445 from Chemtura. The stabilizer is used in the amount from about 0.1 weight percent to about 5 weight percent, in another embodiment from about 0.1 weight percent to about 3 weight percent, and in another embodiment from about 0.5 weight percent to about 1.5 weight percent of the TPU composition.

In addition, various conventional inorganic flame retardant components may be employed in the TPU composition. Suitable inorganic flame retardants include any of those known to one skilled in the art, such as metal oxides, metal oxide hydrates, metal carbonates, ammonium phosphate, ammonium polyphosphate, calcium carbonate, antimony oxide, clay, mineral clays including talc, kaolin, wollastonite, nanoclay, montmorillonite clay which is often referred to as nanoclay, and mixtures thereof. In one embodiment, the flame retardant package includes talc. The talc in the flame retardant package promotes properties of high limiting oxygen index (LOI). The inorganic flame retardants may be used in the amount from 0 to about 30 weight percent, from about 0.1 weight percent to about 20 weight percent, in another embodiment about 0.5 weight percent to about 15 weight percent of the total weight of the TPU composition.

Still further optional additives may be used in the TPU compositions described herein. The additives include colorants, antioxidants (including phenolics, phosphites, thioesters, and/or amines), antiozonants, stabilizers, inert fillers, lubricants, inhibitors, hydrolysis stabilizers, light stabilizers, hindered amines light stabilizers, benzotriazole UV absorber, heat stabilizers, stabilizers to prevent discoloration, dyes, pigments, inorganic and organic fillers, reinforcing agents and combinations thereof.

All of the additives described above may be used in an effective amount customary for these substances. The non-flame retardants additives may be used in amounts of from about 0 to about 30 weight percent, in one embodiment from about 0.1 to about 25 weight percent, and in another embodiment about 0.1 to about 20 weight percent of the total weight of the TPU composition.

These additional additives can be incorporated into the components of, or into the reaction mixture for, the preparation of the TPU foam, or after making the TPU foam.

The disclosed technology also provides a process of making any of the flexible polyurethane foams described herein. The disclosed process includes the steps of: (I) mixing (i) at least one polyol, (ii) at least one isocyanate, (iii) at least one chain extender, (iv) a blowing agent, and optionally (v) one or more crosslinking agents, resulting in a reaction system; and (II) curing the mixture in such a way that the components interact to form a foam.

The disclosed technology provides for the described process where the step of curing the reaction system to the flexible polyurethane foam takes place in a mold.

The disclosed technology provides for the described process where the reaction system is foamed free-risen.

The disclosed technology provides for the described process where the reaction system is foamed closed mold.

The disclosed technology further provides for the use of one or more of the TPU described above to produce a flexible polyurethane injection molded foam, in order to improve the foam processing of the material, relative to the foam processing properties of other TPU. The disclosed technology further provides for the use of one or more of the TPU described above to produce a flexible polyurethane injection molded foam, in order to improve the properties of the resulting foam, relative to the foam prepared from other TPU.

### INDUSTRIAL APPLICATION

The flexible polyurethane injection molded foams described herein may be used in any number of application and/or article. Examples include but are not limited to footwear applications where the flexible polyurethane foams described herein may be used in shoe soles, as well as used in personal protective equipment, sports protective equipment, heat insulation applications, acoustic/sound insulation applications, automotive interior applications, packaging applications, or any other number of applications where foam materials are currently used.

The amount of each chemical component described is presented exclusive of any solvent or diluent oil, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade. Unless otherwise noted, all molecular weight values are weight average molecular weight and may be measured by GPC.

It is known that some of the materials described above may interact in the final formulation, so that the components of the final formulation may be different from those that are initially added. For instance, metal ions (of, e.g., a flame retardant) can migrate to other acidic or anionic sites of other molecules. The products formed thereby, including the products formed upon employing the composition of the technology described herein in its intended use, may not be susceptible of easy description. Nevertheless, all such modifications and reaction products are included within the scope of the technology described herein; the technology described herein encompasses the composition prepared by admixing the components described above.

### Examples

The technology described herein may be better understood with reference to the following non-limiting examples.

A series of polyurethanes are prepared and then foamed to evaluate their foam processing properties. The resulting foam samples are then tested further to evaluate their physical properties and how suitable they are for various end use applications, that is whether the balance good foam processing properties with good physical properties.

The table below summarizes the formulations of the polyurethanes tested.

TABLE 1

| | | | | | | Hard |
|---|---|---|---|---|---|---|
| | | | | M_{w} | M_{w}/Mₙ | Segment |
| Example | Polyol | Isocyanate | Chain Ext | by GPC | by GPC | (%) |
| Comp A | Polyether | Mixed Aromatic | Aliphatic | 341845 | 4.26 | 15 |
| | Polyol | Disocyanate | diol | | | |
| Comp B | Caprolactone | Aromatic | Aliphatic | 94316 | 2.07 | 26.4 |
| | Polyester | Disocyanate | diol | | | |
| Comp C | Dimerate | Aromatic | Mixed | N/A | N/A | 28.5 |
| | Polyester | Disocyanate | Aliphatic | | | |
| | | | diol | | | |
| Comp D | Caprolactone | Aromatic | Aliphatic | 111558 | 2.09 | 29.1 |
| | Polyester | Disocyanate | diol | | | |
| Comp E | Adipate | Aromatic | Aliphatic | 362096 | 2.61 | 32.1 |
| | Polyester | Disocyanate | diol | | | |
| Comp F | Polyether | Aromatic | Aliphatic | 112794 | 2.10 | 36.9 |
| | | Disocyanate | diol | | | |
| Inv G | Polyether | Aromatic | Aromatic | 249845 | 2.51 | 23.9 |
| | | Disocyanate | Diol | | | |
| Inv H | Mixed Adipate | Aromatic | Aliphatic | 149874 | 2.19 | 24.5 |
| | Polyester | Disocyanate | diol | | | |
| Inv I | Polyether | Aromatic | Aliphatic | 204308 | 2.28 | 25.2 |
| | | Disocyanate | diol | | | |
| Inv J | Adipate | Aromatic | Aliphatic | 301415 | 2.48 | 26.4 |
| | Polyester | Disocyanate | diol | | | |
| Inv K | Polyether | Aromatic | Aliphatic | 120253 | 2.10 | 27.8 |
| | | Disocyanate | diol | | | |
| Inv L | Mixed Adipate | Aromatic | Aliphatic | 208598 | 2.33 | 28.4 |
| | Polyester | Disocyanate | diol | | | |
| Inv M | Polyether | Aromatic | Aliphatic | 133793 | 2.12 | 40.3 |
| | | Disocyanate | diol | | | |
| Inv N | Polyether | Aromatic | Aliphatic | 151522 | 2.17 | 43.3 |
| | | Disocyanate | diol | | | |
| Inv O | Caprolactone | Aromatic | Aromatic | 123958 | 2.31 | 47.9 |
| | Polyester | Disocyanate | Diol | | | |
| Inv P | Polyether | Aromatic | Aliphatic | 191225 | 2.34 | 48.1 |
| | | Disocyanate | diol | | | |
| Inv Q | Polyether | Aromatic | Aromatic | 228575 | 2.44 | 19.2 |
| | | Disocyanate | Diol | | | |
| Inv R | Adipate | Aromatic | Aliphatic | 235718 | 2.29 | 23.4 |
| | Polyester | Disocyanate | diol | | | |
| Inv S | Mixed Adipate | Aromatic | Aliphatic | 478218 | 2.46 | 24.8 |
| | Polyester | Disocyanate | diol | | | |
| Inv T | Mixed Adipate | Aromatic | Aliphatic | 130748 | 1.85 | 29.1 |
| | Polyester | Disocyanate | diol | | | |

Example E is included as a baseline material. This example is representative of TPU that is commercially available for use in the preparation of injection molded foams. The foams of this invention provide processing improvements of foams made from these type of TPU as well as improved performance properties in the resulting foam.

Each of the polyurethanes described in Table 1 above is plasticized by the thermal energy, which is provided by a heated barrel and shear energy by screw rotation within the barrel. Once the polyurethane is fully plasticized within the barrel, a physical blowing agent, in a super critical fluid state, is directly injected into the barrel and solubilized into the plasticized polyurethane. The injected physical blowing agent and molten polyurethane are homogenized via rotation of a screw which has specially designed mixing sections. A set volume of the homogenized blowing agent and polyurethane mixture is then injected into a confined mold. During the injection stage, the blowing agent and polyurethane mixture starts its initial foaming process. When the injection is completed, the pressure of the mold is released and secondary foaming takes place, resulting in a flexible polyurethane injection molded foam.

As each polyurethane material is foamed it is rated on its foam processing properties. A summary of these ratings is presented in the table below where the ratings range from 0 to 10 with a 0 indicating untestable performance and a 10 indicating the best possible performance. The areas where the samples are rated included shot to shot consistency of the material, sample uniformity, surface quality of the resulting foam, the expansion capability of the material, and the foam structure focusing on uniformity of voids and the lack of large voids.

TABLE 2

| | Shot-to-shot | Sample | Surface | Expansion | Foam |
|---|---|---|---|---|---|
| Example | consistency | uniformity | quality | capability | structure |
| Comp A | 0 | 0 | 0 | 0 | 0 |
| Comp B | 2 | 2 | 3 | 1 | 1 |
| Comp C | 5 | 1 | 1 | 1 | 1 |
| Comp D | 2 | 7 | 4 | 1 | 2 |
| Comp E | 5 | 2 | 5 | 5 | 2 |
| Comp F | 3 | 3 | 3 | 3 | 1 |
| Inv G | 7 | 6 | 1 | 6 | 5 |
| Inv H | 9 | 9 | 7 | 7 | 8 |
| Inv I | 8 | 8 | 8 | 5 | 7 |
| Inv J | 8 | 5 | 7 | 5 | 5 |
| Inv K | 7 | 7 | 3 | 3 | 6 |
| Inv L | 7 | 8 | 7 | 5 | 8 |
| Inv M | 8 | 9 | 6 | 5 | 8 |
| Inv N | 8 | 6 | 6 | 8 | 8 |
| Inv O | 7 | 8 | 6 | 8 | 9 |
| Inv P | 8 | 8 | 7 | 8 | 8 |
| Inv Q | 5 | 1 | 7 | 2 | 1 |
| Inv R | 6 | 2 | 3 | 5 | 3 |
| Inv S | 8 | 4 | 9 | 2 | 4 |
| Inv T | 9 | 9 | 5 | 5 | 8 |

The results show that the polyurethane materials of the invention have very good foam processing properties compared to other polyurethane materials. In other words, the inventive examples have better overall ratings than the comparative examples in one or more areas while having at least comparable ratings in the other areas evaluated. Some examples have better ratings across all areas evaluated. The flexible polyurethane foams made from a reaction system that includes at least one polyol, at least one isocyanate, and at least one chain extender where the polyurethane has: (a) a weight average molecular weight of 120,000 to 500,000, and (b) a dispersity (M_{w}/Mₙ) of 1.85 to 2.51, show better overall ratings in there foam processing properties compared to the other materials, and particularly compared to the baseline material.

Each polyurethane material that can be processed into flexible polyurethane foam is then tested to evaluate its physical properties. A summary of these results is presented in the table below, which includes the melting temperature of the TPU, Tm, the crystallization temperature of the TPU, Tc, and the difference between the two values, delta (Tm−Tc), all measured by DSC, and compression set (CS) at room temperature (RT) and 50° C. by ASTM D395.

TABLE 3

| | Vertical | | | | | | | |
|---|---|---|---|---|---|---|---|---|
| | Rebound | CS at | CS at 50° C. | Asker C | | | | Melt |
| | [%] | RT [%] | [%] | hardness | | | | strength |
| | ASTM | ASTM | ASTM | ASTM | Peak Tm | Peak Tc | Delta | [N] |
| Example | D2632 | D395 | D395 | D2240 | by DSC | by DSC | (Tm − Tc) | Rheoten |
| Comp A | N/A | N/A | N/A | N/A | 109.94 | −26.19 | 136.13 | N/A |
| Comp B | N/A | N/A | N/A | N/A | 136.79 | 53.73 | 83.06 | N/A |
| Comp C | N/A | N/A | N/A | N/A | 106.07 | N/A | N/A | N/A |
| Comp D | N/A | N/A | N/A | N/A | 114.35 | 28.50 | 85.85 | N/A |
| Comp E | 42.83 | 32.19 | 77.07 | 50.14 | 135.82 | 61.83 | 73.99 | 0.240 |
| Comp F | N/A | N/A | N/A | N/A | 134.03 | 66.62 | 67.41 | 0.009 |
| Inv G | 49.33 | 5.39 | 11.44 | 44.00 | 147.24 | 99.23 | 48.01 | 0.185 |
| Inv H | 43.08 | 33.76 | 62.81 | 45.50 | 135.82 | 42.61 | 93.21 | 0.049 |
| Inv I | 44.58 | 20.22 | 47.55 | 45.86 | 182.20 | 78.09 | 104.11 | 0.110 |
| Inv J | 46.75 | 32.67 | 84.53 | 38.08 | 143.15 | 87.75 | 55.40 | 0.528 |
| Inv K | 50.83 | 4.10 | 23.92 | 50.43 | 167.58 | 98.39 | 69.19 | 0.183 |
| Inv L | 40.50 | 5.46 | 31.13 | 49.57 | 143.60 | 119.42 | 24.18 | 0.431 |
| Inv M | 43.17 | 5.18 | 37.17 | 61.14 | 138.48 | 79.88 | 58.60 | 0.046 |
| Inv N | 37.67 | 8.36 | 45.60 | 61.86 | 143.53 | 88.90 | 54.63 | 0.084 |
| Inv O | 21.33 | 6.52 | 47.16 | 69.00 | 205.93 | 204.01 | 1.92 | N/A |
| Inv P | 32.08 | 7.41 | 42.48 | 65.00 | 152.33 | 97.70 | 54.63 | 0.122 |
| Inv Q | 36.00 | 75.92 | 67.42 | 30.14 | 132.23 | 75.96 | 56.27 | N/A |
| Inv R | 43.50 | 4.77 | 51.89 | 45.33 | 156.25 | 58.76 | 97.49 | 0.003 |
| Inv S | 31.50 | 8.81 | 81.36 | 38.14 | 165.55 | 115.19 | 50.36 | 0.086 |
| Inv T | 45.83 | 4.86 | 44.16 | 48.86 | 151.58 | 70.28 | 81.30 | N/A |

The results show that that many of the polyurethane materials of the invention have a very good balance of good foam processing properties and good physical properties compared to other polyurethane materials. An N/A indicates the sample could not be foamed, and further a Tc could not be measured for Comparative Example C. In particular, polyurethane materials that have: (a) a weight average molecular weight of 120,000 to 500,000, and (b) a dispersity (M_{w}/Mₙ) of 1.85 to 2.51, and then which also have: a hard segment content of from 23.5 to 45.0 percent by weight; and a polyol component includes a polyether polyol which in some embodiments includes PTMEG, give a particularly good balance. In addition, polyurethane materials that have: (a) a weight average molecular weight of 120,000 to 500,000, and (b) a dispersity (M_{w}/Mₙ) of 1.85 to 2.51, and then which also have: a hard segment content of from 24 to 30 percent by weight, and a polyol component includes a polyester polyol provide a good balance, as do polyurethane materials that have: (a) a weight average molecular weight of 120,000 to 500,000, and (b) a dispersity (M_{w}/Mₙ) of 1.85 to 2.51, and then which also have: a hard segment content of more than 30 percent by weight or even from 30 to 50 or from 40 to 50 percent by weight; and a polyol component includes a polycaprolactone polyol.

Each of the documents referred to above is incorporated herein by reference, including any prior applications, whether or not specifically listed above, from which priority is claimed. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the technology described herein can be used together with ranges or amounts for any of the other elements.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the basic and novel characteristics of the composition or method under consideration. That is “consisting essentially of” permits the inclusion of substances that do not materially affect the basic and novel characteristics of the composition under consideration.

While certain representative embodiments and details have been shown for the purpose of illustrating the subject technology described herein, it will be apparent to those skilled in this art that various changes and modifications can be made therein without departing from the scope of the subject invention. In this regard, the scope of the technology described herein is to be limited only by the following claims.

1. A flexible thermoplastic polyurethane injection molded foam comprising the reaction product of a reaction system, wherein the reaction system comprises:
a thermoplastic polyurethane comprising (i) at least on polyol, wherein the polyol is selected from polytetramethylene ether glycol, polycaprolactone polyester polyol, and polyester polyol derived from adipic acid,
(ii) at least one isocyanate, and
(iii) at least one chain extender; and
a blowing agent and/or a cell opening surfactant,
wherein the thermoplastic polyurethane has:
(a) a weight average molecular weight of 120,000 to 500,000, and
(b) a dispersity (M_{w}/Mₙ) of 1.85 to 2.51.

2. The flexible thermoplastic polyurethane injection molded foam of claim 1 where the flexible polyurethane foam has:
a peak temperature of crystallization, as measured by DSC, between 40° C. and 205° C.;
(ii) a peak temperature of melting, as measured by DSC, between 106° C. and 206° C.; and
(iii) a difference between the peak temperature of melting and the peak temperature of crystallization, each as measured by DSC, between 1 degree and 137 degrees; and
(iv) a melt strength, as measured by Rheoten, between 0.003 and 0.6 N.

3. The flexible thermoplastic polyurethane injection molded foam of claim 1 where the flexible polyurethane foam has:
(i) a vertical rebound, as measured by ASTM D2632, of at least 30%;
(ii) a compression set at room temperature, as measured by ASTM D395, of no more than 25%;
(iii) a compression set at 50° C., as measured by ASTM D395, of no more than 50%; and
(iv) an Asker C hardness, as measured by ASTM D2240, of 30 to 65.

4. (canceled)

5. The flexible thermoplastic polyurethane injection molded foam of claim 1 wherein said blowing agent comprises water.

6. The flexible thermoplastic polyurethane injection molded foam of claim 1 wherein the blowing agent comprises: a linear, branched or cyclic C₁-C₆ hydrocarbon; a linear, branched or cyclic C₁-C₆ (hydro)fluorocarbon; N₂; O₂; argon; CO₂; or any combination thereof.

7. The flexible thermoplastic polyurethane injection molded foam of claim 1 wherein the cell opening surfactant comprises one or more silicones, siloxane copolymers, non-siloxane co-polymers, non-silicones, or any combination thereof.

8. The flexible thermoplastic polyurethane injection molded foam of claim 1 wherein the polyurethane has a hard segment content of from 23.5 to 45.0 percent by weight, and wherein the polyol component comprises polytetramethylene ether glycol.

9. The flexible thermoplastic polyurethane injection molded foam of claim 1 wherein the polyurethane has a hard segment content of from 24 to 30 percent by weight, and wherein the polyol component comprises a polyester polyol derived from adipic acid.

10. The flexible thermoplastic polyurethane injection molded foam of claim 1 wherein the polyurethane has a hard segment content of greater than 30 percent by weight, and wherein the polyol component comprises a polycaprolactone polyester polyol.

11. The flexible thermoplastic polyurethane injection molded foam of claim 1 wherein the chain extender comprises 1,4-butandiol, benzene glycol, or any combination thereof.

12. The flexible polyurethane injection molded foam of claim 1 wherein the polyol comprises polytetramethylene ether glycol.

13. A process for producing a flexible thermoplastic polyurethane injection molded foam wherein the process comprises:
(I) mixing (i) at least one polyol wherein the polyol is selected from polytetramethylene ether glycol, polycaprolactone polyester polyol, and polyester polyol derived from adipic acid, at least one isocyanate, (iii) at least one chain extender, and optionally (iv) one or more crosslinking agents, resulting in a reaction system that provides a thermoplastic plastic polyurethane composition;
(II) mixing the polyurethane composition and a blowing agent, resulting in a foaming mixture; and
(III) injection molding the foaming mixture in such a way that the components interact to form a foam
where the polyurethane has:
(a) a weight average molecular weight of 120,000 to 500,000, and
(b) a dispersity (M_{w}/Mₙ) of 1.85 to 2.51.

14. The process of claim 13 wherein the step of injection molding the reaction system to the flexible thermoplastic polyurethane injection molded foam takes place in a mold.

15. The process of claim 14 wherein the reaction system is foamed closed mold.
